(19) United States
(12) Patent Application Publication
(10) Pub. No.: US 2022/0287814 A1
(43) Pub. Date: Sep. 15, 2022

(54) RECOVERY PET VEST

(71) Applicant: ACORN PET PRODUCTS LLC, Scottsdale, AZ (US)

(72) Inventors: DAVID SPARKS, SCOTTSDALE, AZ (US); COLIN BRODIE, SCOTTSDALE, AZ (US)

(21) Appl. No.: 17/579,765

(22) Filed: Jan. 20, 2022

Related U.S. Application Data
(63) Continuation-in-part of application No. 17/195,958, filed on Mar. 9, 2021.

(51) Int. Cl. A61D 9/00

(52) U.S. Cl. CPC A61D 9/00

(57) ABSTRACT

A post-surgery garment for a four-legged animal has a one-piece body member having a bottom section, an open top section opposing the bottom section, a rear section, a front section opposing the rear section and a pair of opposing side sections. Each of the opposing side sections run from the bottom section to the open top section and from the front section to the rear section. A pair of front leg openings is formed through the bottom section and located adjacent the front section. The pair of front leg openings is positioned so that one of the pair of front leg openings is formed proximate each of the opposing side sections. A pair of rear leg openings is formed through the bottom section and located adjacent to the rear section. The pair of rear leg openings is positioned so that one of the pair of rear leg openings is formed proximate each of the opposing side sections. An adjustable rear sleeve extends down from each of the pair of rear leg openings. A plurality of straps extends up from each of the pair of opposing side sections and proximate the open top section. The plurality of straps is aligned so that a plurality of straps extending up from one of the pair of opposing side sections is positioned across from and aligned with a corresponding strap from the plurality of straps extending up from the second of the pair of opposing side sections. A protective collar is attached to the open top section and the front section.

### RELATED APPLICATIONS

This patent application is a Continuation-In-Part of U.S. patent application Ser. No. 17/195,958, filed on Mar. 9, 2021, entitled “RECOVERY PET VEST” in the name of the same inventors, and which is incorporated herein by reference in its entirety.

### TECHNICAL FIELD

The present application generally relates to a pet garment, and more specifically, to a garment for four legged pets that prevents the pet from accessing surgical wounds without otherwise restricting the pet's freedom of movement.

### BACKGROUND

Most people enjoy pet ownerships. This is exemplified by the amount of money people spend on their pets. For example, in 2019, Americans spent a record $95.7 billion on their pets, according to the American Pet Products Association's 2019-20 National Pet Owners Survey. The bulk of the money individuals spend on pets was for food, with spending being around $36.9 billion. After food, veterinary care was the second-highest source of spending, with pet owners spending around $29.3 billion

Pets may require veterinary care for a multitude of reasons. Many of these reasons may require the pet owner to protect an area of the pet body from being scratched by the pet. For example, many dogs and cats may be neutered or spayed. Care of the animal, post-surgery, may present problems. In particular, it is important to protect the surgical site so that stitches are not torn or bandages covering the wound are not displaced. This should be done so that the wound can heal quickly and the chances of any infection may be minimized. Further, normal dog and cat behavior, which includes licking at their fur and pawing at their bodies (scratching) creates the risk of damage to the surgical site and the risk of infection.

Among known procedures to avoid contact of the animal with the dressing, the most common is the use of the “Elizabethan” collar in the shape of a cone. A pet cone is a protective medical device worn by the animal. The pet cone is generally a semicircle piece of material that forms a cone when secured around the animal's neck. Materials such as a stiff fabric or plastic material may be used to form the pet cone. Alternatively, an inflatable pouch, or foam or padding secured inside a fabric cover that wraps around the animal's neck may be used. By securing the pet cone around the neck of the animal, the design and shape of the pet cone may prevent the animal from biting and/or licking its body/head where the wound or injury is located allowing the wound/injury to heal. The drawback of the pet cone lies in the fact that the animal may lose track of space because the collar obscures peripheral vision, and is uncomfortable for the animal to move, eat, lie down, etc.

In the past, various types of post-surgical garments, have been proposed for wearing by animals. Some of these garments may be of a one-piece construction, and others are of a two-piece construction. While all of these garments provide some protection to the animal wearing them, all have some drawback. For example, some garments cannot be readily fastened about the animal, or require a lot of time and effort to put on the animal. Other types of these garments do not fully cover and protect the surgical site.

Therefore, it would be desirable to provide a system and method that overcomes the above.

### SUMMARY

In accordance with one embodiment, a post-surgery garment for a four-legged animal is disclosed. The post-surgery garment for a four-legged animal has a one-piece body member having a bottom section, an open top section opposing the bottom section, a rear section, a front section opposing the rear section and a pair of opposing side sections. Each of the opposing side sections run from the bottom section to the open top section and from the front section to the rear section. A pair of front leg openings is formed through the bottom section and located adjacent the front section. The pair of front leg openings is positioned so that one of the pair of front leg openings is formed proximate each of the opposing side sections. A pair of rear leg openings is formed through the bottom section and located adjacent to the rear section. The pair of rear leg openings is positioned so that one of the pair of rear leg openings is formed proximate each of the opposing side sections. An adjustable rear sleeve extends down from each of the pair of rear leg openings. A plurality of straps extends up from each of the pair of opposing side sections and proximate the open top section. The plurality of straps is aligned so that a plurality of straps extending up from one of the pair of opposing side sections is positioned across from and aligned with a corresponding strap from the plurality of straps extending up from the second of the pair of opposing side sections. A protective collar is attached to the open top section and the front section.

In accordance with one embodiment, a post-surgery garment for a four-legged animal is disclosed. The post-surgery garment has a one-piece body member having a bottom section, an open top section opposing the bottom section, a rear section, a front section opposing the rear section and a pair of opposing side sections. Each of the opposing side sections run from the bottom section to the open top section and from the front section to the rear section. A pair of front leg openings is formed through the bottom section and located adjacent the front section. The pair of front leg openings is positioned so that one of the pair of front leg openings is formed proximate each of the opposing side sections. A pair of rear leg openings is formed through the bottom section and located adjacent to the rear section. The pair of rear leg openings is positioned so that one of the pair of rear leg openings is formed proximate each of the opposing side sections. A front sleeve extends down from each of the pair of front leg openings. A rear sleeve extends down from each of the pair of rear leg openings. An adjustable cuff is formed at a distal end of each of the rear sleeves. A slit is formed through the adjustable cuff and runs a height of the adjustable cuff. Connectors are applied on each side of the slit securing the slit together and to adjust a width of an opening of the adjustable cuff. A plurality of straps extends up from each of the pair of opposing side sections and proximate the open top section, the plurality of straps aligned so that a plurality of straps extending up from one of the pair of opposing side sections is positioned across from and aligned with a corresponding strap from the plurality of straps extending up from the second of the pair of opposing side sections. Strap connectors are attached to a distal end of each of the plurality of straps, the strap connectors allowing one to adjust a size of the open top section. A protective collar is attached to the open top section and the front section. The protective collar member comprises a bladder attached to the open top section and the front section. A mechanism is attached to the bladder adjusting a firmness of the bladder. A cover is positioned over the bladder.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is an elevated perspective view on an exemplary embodiment of a post-surgery animal recovery vest in accordance with an embodiment of the present invention;

FIG. 2 is a font view on an exemplary embodiment of the post-surgery animal recovery vest of FIG. 1 in accordance with an embodiment of the present invention;

FIG. 3 is a rear view on an exemplary embodiment of the post-surgery animal recovery vest of FIG. 1 in accordance with an embodiment of the present invention;

FIG. 4 is a left side view on an exemplary embodiment of the post-surgery animal recovery vest of FIG. 1 in accordance with an embodiment of the present invention;

FIG. 5 is a right side view on an exemplary embodiment of the post-surgery animal recovery vest of FIG. 1 in accordance with an embodiment of the present invention;

FIG. 6 is a top view on an exemplary embodiment of the post-surgery animal recovery vest of FIG. 1 in accordance with an embodiment of the present invention;

FIG. 7 is a bottom view on an exemplary embodiment of the post-surgery animal recovery vest of FIG. 1 in accordance with an embodiment of the present invention;

FIG. 8 is a front view on an exemplary embodiment of an inflatable member used in the post-surgery animal recovery vest of FIG. 1 in accordance with an embodiment of the present invention;

FIG. 9 is a bottom view on an exemplary embodiment of the inflatable member of FIG. 8 in accordance with an embodiment of the present invention; and

FIG. 10 is a rear view on an exemplary embodiment of the inflatable member of FIG. 8 in accordance with an embodiment of the present invention.

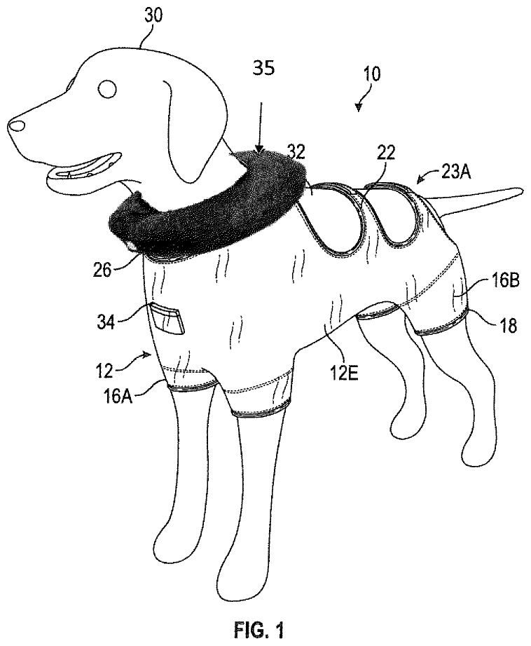

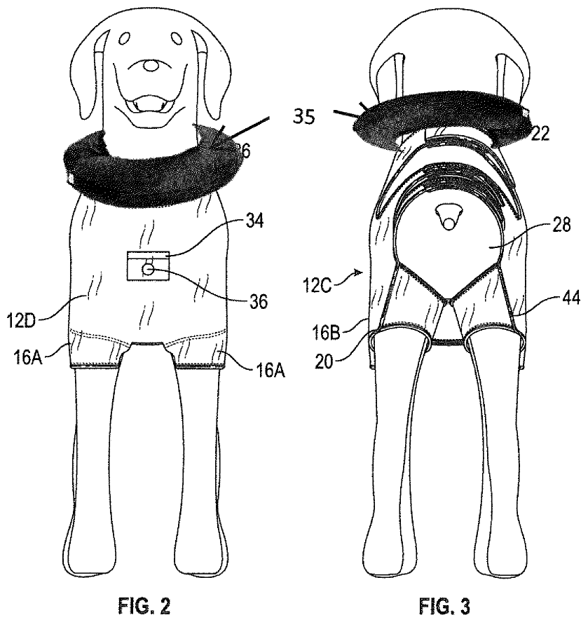

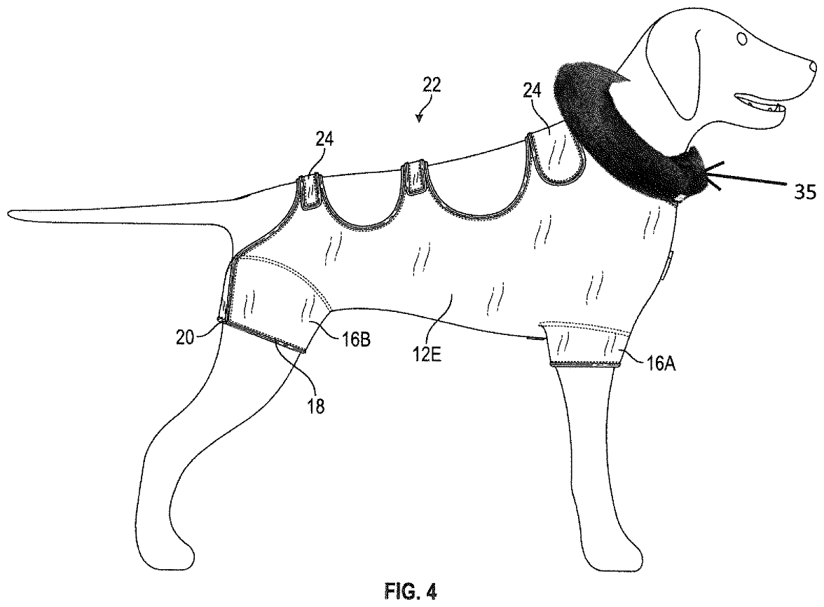

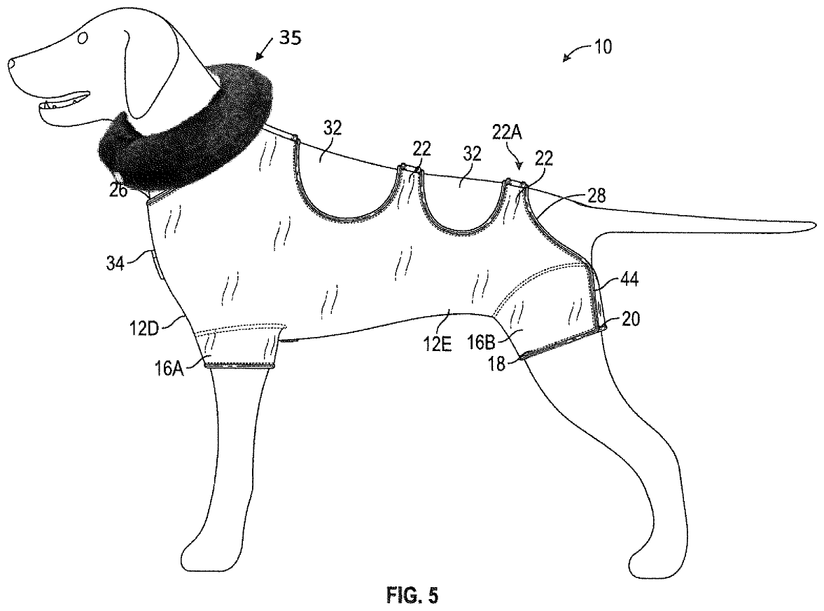

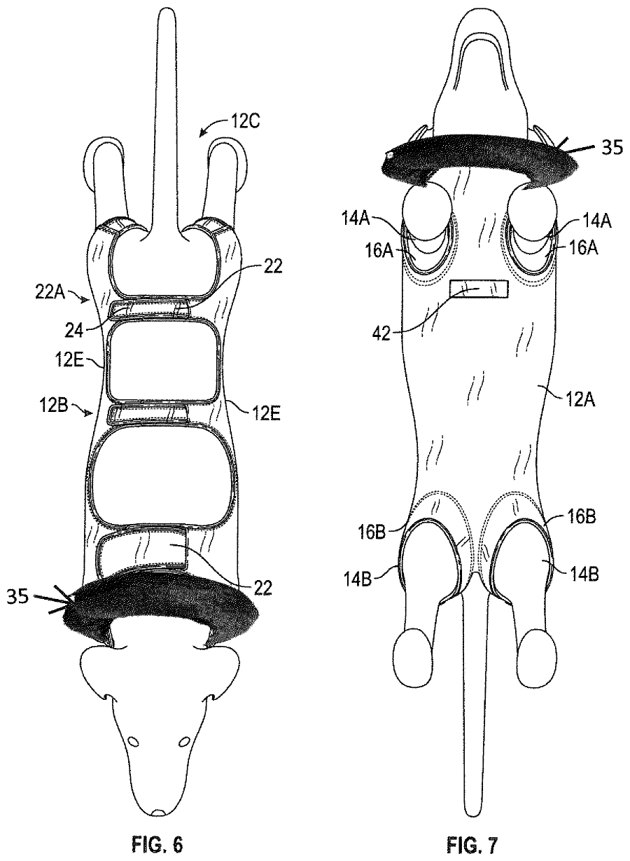

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a post-surgery animal recovery smart vest (hereinafter vest). The vest is designed to have a plurality of unique easy secure straps that may allow for adjustment in the size of the vest based on girth of the pet. The vest may have adjustable rear leg cuffs which may allow the vest to form a secure fitting to the hind legs of the animal. The vest may have a calming pocket located in a front chest area or other areas of the vest and which may be used to hold different therapeutic aroma delivery devices to be stored therein as long as it is close enough for the animal to smell the calming fragrance. The vest may have a protective collar secured to the front panel of the vest. The protective collar may be filled to different levels based on a desired utilization for the pet.

Referring to the FIGs., a single piece garment 10 may be shown. The garment 10 may be used by an animal 30 post surgery to protect a surgical site on the animal 30 so that stitches may not be torn or bandages covering the wound may not be displaced. In general, the animal 30, may be a four-legged domesticated pet such as a dog or a cat. As may be seen in the FIGs., the garment 10 may have a one-piece body member 12 having a bottom section 12A, an open top section 12B opposing the bottom section 12A, a rear section 12C, a front section 12D opposing the rear section 12C and a pair of opposing side sections 12E. Each of the side sections 12E running from the bottom section 12A to the open top section 12B and from the front section 12D to the rear section 12C. A protective collar 35 may be attached to the open top section 12B and the front section 12D.

The bottom section 12A may have a pair of front leg openings 14A located adjacent the front section 12D. The pair of front leg openings 14A may be arranged so that one of the pair of front leg openings 14A may be formed proximate each side sections 12E. A front sleeve 16A may extend down from each of the pair of front leg openings 14A. The front sleeve 16A may be tapered so that the front sleeve 16A is narrow at a distal end thereof.

The bottom section 12A may have a pair of rear leg openings 14B located adjacent to the rear section 12C. The pair of rear leg openings 14B may be arranged so that one of the pair of rear leg openings 14B may be formed proximate each side sections 12E. A rear sleeve 16B may extend down from each of the pair of rear leg openings 14B. The rear sleeve 16B may be adjustable in width to form a more secure fitting to the hind legs of the animal 30. In accordance with one embodiment, the rear sleeve 16B may be adjustable by having an adjustable cuff 18 formed at a distal end of the rear sleeve 16B. A slit 20 may be formed through the adjustable cuff 18. The slit 20 may run a height of the adjustable cuff 18. In accordance with one embodiment, the slit 20 may run through a height of the adjustable cuff 18 and into the rear sleeve 16B. Connectors 22 may be applied on each side of the slit 20. The connectors 44 may be used to secure the slit 20 and to adjust the width of the opening of the adjustable cuff 18. In accordance with one embodiment, the connectors 44 may be hook and loop material.

A plurality of straps 22 may extend up from each of the pair of opposing side sections 12E. The plurality of straps 22 may extend up each of the pair of opposing side sections 12E proximate the open top section 12B. In the embodiment shown, three straps 22 may be shown extending up each of the pair of opposing side sections 12E proximate the open top section 12B. However, this is shown as an example, and more or less than three may be used. The plurality of straps 22 may be aligned such that the plurality of straps 22 extending up from one of the pair of opposing side sections 12E is positioned across from and aligned with a corresponding strap 22 from the plurality of straps 22 extend up from the second one of the pair of opposing side sections 12E.

The plurality of straps 22 may be used to secure the animal 30 within the garment 10. Each of the plurality of straps 22 may have connectors 24 attached thereto. The connectors 24 may be used to attach each of the plurality of straps 22 extending up from one of the pair of opposing side sections 12E to a corresponding strap 22 extending up from the second one of the pair of opposing side sections 12E to form a plurality of semi-circular straps 22A across the open top section 12B. The plurality of semi-circular straps 22A across the open top section 12B may be used to secure the animal 30 within the garment 10. The connectors 24 may be configured to allow a user to adjust the size of the semi-circular straps 22A formed. This may allow the garment 10 to be used for different sized animals 30. The connectors 24 may be snaps, hook and loop, or similar devices.

A first pair of the plurality of straps 22 may extend up such that one of the first pair of the plurality of straps 22 may be positioned on each of the pair of opposing side sections 12E and setback from the front section 12D of the garment 10. When the first pair of the plurality of straps 22 are attached together, they form a first of the plurality of semi-circular straps 22A across the open top section 12B, an opening 26 may be formed proximate the front section 12D. The opening 26 may be where a head of the animal 30 may extend out from the garment 10. In accordance with on embodiment, the first pair of the plurality of straps 22 may be thicker in width than the other plurality of straps 22 to ensure that the first pair of the plurality of straps 22 stay attached.

A last pair of the plurality of straps 22 may extend up such that one of the last pair of the plurality of straps 22 are positioned on each of the pair of opposing side sections 12E and setback from the rear section 12C of the garment 10. When the last pair of the plurality of straps 22 are attached together to form a last of the plurality of semi-circular straps 22A across the open top section 12B, an opening 28 may be formed proximate the rear section 12C. The opening 28 may be where a tail and rear end of the animal 30 may extend out from the garment 10.

One or more middle pairs of the plurality of straps 22 may extend up such that one of the middle pairs of the plurality of straps 22 is positioned on each opposing side sections 12E and positioned in-between the first pair and the last pair of the plurality of straps 22. Openings 32 may be formed in-between adjacent pairs of the plurality of straps 22. The openings 32 may provide ventilation for the animal 30 as well as provide a more relaxed and less restrictive fit of the garment 10 on the animal 30.

A pocket 34 may be formed on the front section 12D or on the side of the garment 10 close enough for the animal to smell the calming fragrance. The pocket 34 may be used to secure a therapeutic aroma disk 36. A scent may emanate from the therapeutic aroma disk 36 towards a nose of the animal 30. The scent may provide aromatherapy to the animal 30 and may help to relieve stress, fear, agitation and the like from the animal 30. A front area of the pocket 34 may be formed of a mesh material to help disperse the scent emanating from the therapeutic aroma disk 36.

The protective collar 35 may be attached to the open top section 12B and the front section 12D of the body member 12. In accordance with one embodiment, the protective collar 35 may be formed around a perimeter of the opening 26 where the head of the animal 30 may extend out from the body member 12. The protective collar 35 may be positioned around a neck the animal 30 when the head of the animal 30 extends out from the garment 10. The protective collar 35 may be used to prevent the animal from biting and licking a body part of the animal that may have sustained an injury or undergo surgery.

The protective collar 35 may have a bladder 50. The bladder 50 may be filled with air or stuffing such as a foam or other soft material. The bladder 50 may be adjustable so that it may be filled to different levels based on a desired utilization for the pet. If air is used, an air valve 51 may be attached to and in communication with an interior of the air bladder 50. The air valve 51 may be used to inflate and deflate the bladder 50. In accordance with one embodiment, a user may inflate the bladder 50 by pinching the air valve 51 and blowing into the bladder 50. Alternatively, the bladder 50 may have a resealable opening 57. The resealable opening 57 may allow one to insert or remove stuffing from the bladder 50 in order to adjust the firmness of the bladder 50.

The bladder 50 may come in different shapes such as a semicircular shape, an upside-down “U” shape, an “O” shape or the like. In accordance with one embodiment, the bladder 50 may be formed in a shape of an “O”. A slit 52 may be formed in bottom area of the “O” shape bladder 50. The slit 52 may be used to allow one to separate apart the legs forming the “O” shape bladder 50.

A closure device 53 may be coupled to the slit 52. The closure device 53 may be used to adjust the size of an opening of the slit 52 in order to and adjust and secure the “O” shape bladder 50 around the pet's neck. The closure device 53 may be placed along a bottom surface of the “O” shape bladder 50 across the slit 52. Alternatively, or in addition to, the closure device 50 may be positioned on either or both a bottom rear or bottom front surface of the “O” shape bladder 50 and across the slit 52. In accordance with one embodiment, the closure device 53 may be hook and loop material or similar adjustable closing mechanisms.

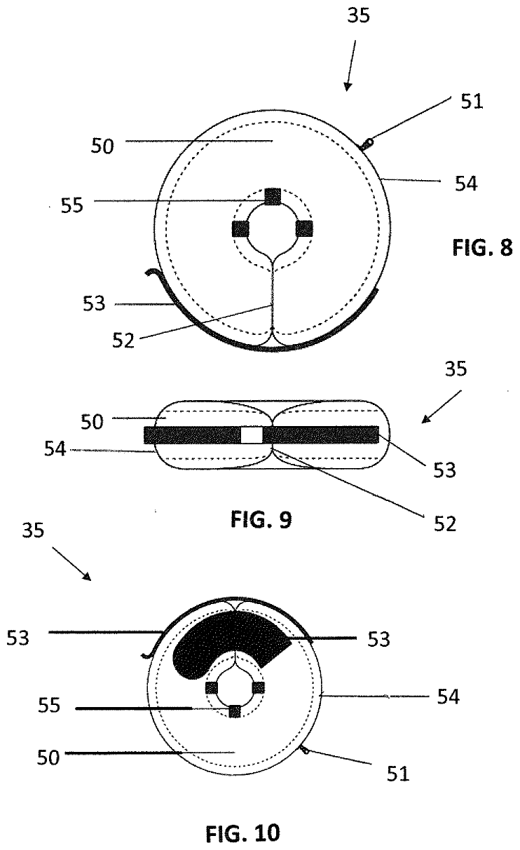

A plurality of hoops 55 may be formed around an inner perimeter of the “O” shape bladder 50. The loops 55 may be formed around an inner perimeter of the “O” shape bladder 50 on either the front or rear surface of the “O” shape bladder 50. In the embodiment shown in FIGS. 8 and 10, the loops 55 may be formed on the rear surface of the “O” shape bladder 50. The loops 55 may be used to allow an existing pet collar to be secure therethrough.

A cover 54 may be placed over the bladder 50. The cover 54 may be uses to protect the bladder 50 from being punctured. It may also be used to provide a softer plusher feeling to the protective collar 35. When the bladder 50 is deflated or the stuffing removed, the cover 54 may be used as a pouch to store the protective collar 35. A zipper may be formed on the cover 54 to allow the cover 54 to be removed as well as to secure the air bladder 50 within the cover 54.

A strap 42 may be positioned behind and in-between the pair of front leg openings 14A. When the garment 10 is rolled forward the strap 42 may be used to retain the garment 10 in a forward position to facilitate the pet going to the bathroom. The garment 10 can then be returned to its original configuration on the pet.

The foregoing description is illustrative of particular embodiments of the application, but is not meant to be a limitation upon the practice thereof. The following claims, including all equivalents thereof, are intended to define the scope of the application.

What is claimed is:

1. A post-surgery garment for a four-legged animal comprising:
a one-piece body member having a bottom section, an open top section opposing the bottom section, a rear section, a front section opposing the rear section and a pair of opposing side sections, each of the opposing side sections running from the bottom section to the open top section and from the front section to the rear section;
a pair of front leg openings formed through the bottom section and located adjacent the front section, the pair of front leg openings positioned so that one of the pair of front leg openings is formed proximate each of the opposing side sections;
a pair of rear leg openings formed through the bottom section and located adjacent to the rear section, the pair of rear leg openings positioned so that one of the pair of rear leg openings is formed proximate each of the opposing side sections;
an adjustable rear sleeve extending down from each of the pair of rear leg openings;
a plurality of straps extending up from each of the pair of opposing side sections and proximate the open top section, the plurality of straps aligned so that a plurality of straps extending up from one of the pair of opposing side sections is positioned across from and aligned with a corresponding strap from the plurality of straps extending up from the second of the pair of opposing side sections; and
a protective collar attached to the open top section and the front section.

2. The post-surgery garment of claim 1, wherein the protective collar comprises:
a bladder attached to the open top section and the front section; and
a device attached to the bladder to adjust a firmness of the bladder.

3. The post-surgery garment of claim 1, wherein the protective collar comprises:
an “O” shaped air bladder attached to the open top section and the front section;
an air valve attached to the air bladder; and
a slit formed in a bottom area of the “O” shaped air bladder.

4. The post-surgery garment of claim 3, comprising an attachment device coupled to the slit to adjust a size opening of the slit.

5. The post-surgery garment of claim 2, comprising a cover positioned over the bladder.

6. The post-surgery garment of claim 1, comprising an adjustable cuff formed at a distal end of each of the rear sleeves.

7. The post-surgery garment of claim 1, comprising:
an adjustable cuff formed at a distal end of each of the rear sleeves;
a slit formed through the adjustable cuff and running a height of the adjustable cuff;
connectors applied on each side of the slit securing the slit and to adjust a width of an opening of the adjustable cuff.

8. The post-surgery garment of claim 1, comprising a front sleeve extending down from each of the pair of front leg openings.

9. The post-surgery garment of claim 1, wherein the plurality of straps comprises:
a first pair of the plurality of straps wherein one of the first pair of the plurality of straps extends up from each of the pair of opposing side sections and setback from the front section, wherein the first pair of the plurality of straps form a head opening proximate the front section when the first pair of the plurality of straps is attached together; and
a last pair of the plurality of straps wherein one of the last pair of the plurality of straps extends up from each of the pair of opposing side sections and positioned in front of the rear section, wherein the last pair of the plurality of straps form a tail opening proximate the rear section when the last pair of the plurality of straps is attached together.

10. The post-surgery garment of claim 9, wherein the plurality of straps comprises a middle pair of the plurality of straps, wherein one of the middle pair of the plurality of straps extends up from each of the pair of opposing side sections and positioned in-between the first pair and the last pair of the plurality of straps.

11. The post-surgery garment of claim 1, comprising strap connectors attached to a distal end of each of the plurality of straps, the strap connectors allowing one to adjust a size of the open top section.

12. The post-surgery garment of claim 1, comprising a pocket attached to the front section for holding an aroma disk.

13. The post-surgery garment of claim 1, comprising a bottom strap between the pair of front leg openings.

14. A post-surgery garment for a four-legged animal comprising:
a one-piece body member having a bottom section, an open top section opposing the bottom section, a rear section, a front section opposing the rear section and a pair of opposing side sections, each of the opposing side sections running from the bottom section to the open top section and from the front section to the rear section;
a pair of front leg openings formed through the bottom section and located adjacent the front section, the pair of front leg openings positioned so that one of the pair of front leg openings is formed proximate each of the opposing side sections;
a pair of rear leg openings formed through the bottom section and located adjacent to the rear section, the pair of rear leg openings positioned so that one of the pair of rear leg openings is formed proximate each of the opposing side sections;
a front sleeve extending down from each of the pair of front leg openings;
a rear sleeve extending down from each of the pair of rear leg openings;
an adjustable cuff formed at a distal end of each of the rear sleeve;
a slit formed through the adjustable cuff and running a height of the adjustable cuff;
connectors applied on each side of the slit securing the slit together and to adjust a width of an opening of the adjustable cuff;
a plurality of straps extending up from each of the pair of opposing side sections and proximate the open top section, the plurality of straps aligned so that a plurality of straps extending up from one of the pair of opposing side sections is positioned across from and aligned with a corresponding strap from the plurality of straps extending up from the second of the pair of opposing side sections;
strap connectors attached to a distal end of each of the plurality of straps, the strap connectors allowing one to adjust a size of the open top section;
a protective collar attached to the open top section and the front section, wherein the protective collar comprises:
a bladder attached to the open top section and the front section;
a mechanism attached to the bladder adjusting a firmness of the bladder, and
a cover positioned over the bladder.

15. The post-surgery garment of claim 14, wherein the connectors are hook and loop material.

16. The post-surgery garment of claim 14, wherein the front sleeve is tapered.

17. The post-surgery garment of claim 14, wherein the plurality of straps comprises:
a first pair of the plurality of straps wherein one of the first pair of the plurality of straps extends up from each of the pair of opposing side sections and setback from the front section, wherein the first pair of the plurality of straps form a head opening proximate the front section when the first pair of the plurality of straps is attached together; and
a last pair of the plurality of straps wherein one of the last pair of the plurality of straps extends up from each of the pair of opposing side sections and positioned in front of the rear section, wherein the last pair of the plurality of straps form a tail opening proximate the rear section when the last pair of the plurality of straps is attached together.

18. The post-surgery garment of claim 17, wherein the plurality of straps comprises a middle pair of the plurality of straps, wherein one of the middle pair of the plurality of straps extends up from each of the pair of opposing side sections and positioned in-between the first pair and the last pair of the plurality of straps.

19. The post-surgery garment of claim 14, comprising a pocket attached to the front section for holding an aroma disk.

20. The post-surgery garment of claim 14, comprising a bottom strap between the pair of front leg openings to retain a partially rolled garment.
